(19) United States
(12) Patent Application Publication
(10) Pub. No.: US 2019/0362128 A1
(43) Pub. Date: Nov. 28, 2019

(54) KNUCKLE-PRINT IDENTIFICATION SYSTEM

(71) Applicants: Wen-Kuei Liu, Taichung City 406 (TW); Chao-Hsuan Liu, Taichung City 406 (TW); Yu-Chun Liu, Taichung City 427 (TW); Yi-Shan Liu, Taichung City 406 (TW)

(72) Inventors: Wen-Kuei Liu, Taichung City 406 (TW); Chao-Hsuan Liu, Taichung City 406 (TW); Yu-Chun Liu, Taichung City 427 (TW); Yi-Shan Liu, Taichung City 406 (TW)

(21) Appl. No.: 15/987,516

(22) Filed: May 23, 2018

(51) Int. Cl. G06K 9/00

(52) U.S. Cl. CPC G06K 9/00087; G06K 9/00067

(57) ABSTRACT

A knuckle-print identification system includes a database, a knuckle-print capturing unit and a processing unit electrically connected to the database and the knuckle-print capturing unit. The database stores a comparison data module. The comparison data module includes two end positions of each of all first knuckle-prints and two end positions of each of all second knuckle-prints of three finger portions in a close state, and data representing relative relationships thereof. The knuckle-print capturing unit captures knuckle-print images of the three finger portions. The processing unit processes the knuckle-print images captured by the knuckle-print capturing unit, and calculates to obtain the end positions of all the knuckle-prints of the three finger portions and relative relationship data to form the comparison data module and store the comparison data module into the database, and to form a to-be-identified characteristic module and compare the to-be-identified characteristic module with the comparison data module.

### BACKGROUND OF THE INVENTION

### 1. Field of the Invention

The invention relates to a technical field of a knuckle-print identification system, and more particularly to a knuckle-print identification system with better security.

### 2. Description of the Prior Art

In general, the conventional knuckle-print identification method is mainly based on the use of the shape of the knuckle-print, the number of primary lines, the distribution positions, the lengths, the relative positions, or extracts multiple predetermined feature points from the knuckle-prints of the first and second knuckles of the middle finger, the knuckle-prints of the first knuckle of the index finger, and the knuckle-prints of the first knuckle of the ring finger to constitute a predetermined polygon functioning as the identification feature. However, the above-mentioned identification method uses fewer identification feature points, so relative relationships of geometric patterns, which can be formed by the fewer identification feature points, can also be relatively simple and thus have poor security.

In view of this, the present inventor has made deep conceiving, active research, improvements and tries to solve the above-mentioned problems, and thus developed and designed the present invention.

### SUMMARY OF THE INVENTION

A main objective of the invention is to solve the problem of the poor security in the conventional knuckle-print identification method.

A knuckle-print identification system of the invention includes a database, a knuckle-print capturing unit and a processing unit. The database stores a comparison data module, the comparison data module includes two end positions of each of all first knuckle-prints and two end positions of each of all second knuckle-prints of three finger portions in a close state, and data representing relative relationships thereof. The knuckle-print capturing unit captures knuckle-print images of the three finger portions. The processing unit, electrically connected to the database and the knuckle-print capturing unit, is configured with a predetermined conformity rate in advance, processes the knuckle-print images captured by the knuckle-print capturing unit, and calculates to obtain the end positions of all the knuckle-prints of the three finger portions and relative relationship data to form the comparison data module and store the comparison data module into the database, and to form a to-be-identified characteristic module and to compare the to-be-identified characteristic module with the comparison data module to obtain an identification conformity rate. The processing unit judges as true when the identification conformity rate is higher than or equal to the predetermined conformity rate, and the processing unit judges as fault when the identification conformity rate is lower than the predetermined conformity rate.

In the knuckle-print identification system provided by the invention, because the comparison data module includes 12 end positions of knuckle-prints, which include two end positions of each of all first knuckle-prints and two end positions of each of all second knuckle-prints of three finger portions in a close state, it has at most 12 identification feature points, and the relative relationships thereof have relatively more changes according to the 12 identification feature points. Therefore, the system is more secure.

In the knuckle-print identification system provided by the invention, the comparison data module further includes the two end positions of each of all the second sub-knuckle-prints of the three finger portions, so that all of them have up to 18 identification feature points. It is even more likely to add relatively more changes to the relative relationships thereof according to the 18 identified feature points to further increase its security.

The knuckle-print identification system provided by the invention may further include a setting unit. The setting unit is electrically connected to the processing unit, and can select the end positions of the knuckle-prints and set the relative relationships thereof, so that the relative relationships may be formed by selecting an appropriate number of end positions of knuckle-prints according to personal needs, and that the effect of adjusting the level of security can be achieved.

### BRIEF DESCRIPTION OF THE DRAWINGS

FIG. 1 is a system architecture diagram of the invention.

FIG. 2 is a schematic flow chart showing setting of a comparison data module of the invention.

FIG. 3 is a schematic view showing three finger portions of the invention.

FIG. 4 is a view showing several relative relationship aspects of the comparison data module of the invention.

FIG. 5 is a schematic flow chart showing the identification of the invention.

### DETAILED DESCRIPTION OF THE PREFERRED EMBODIMENTS

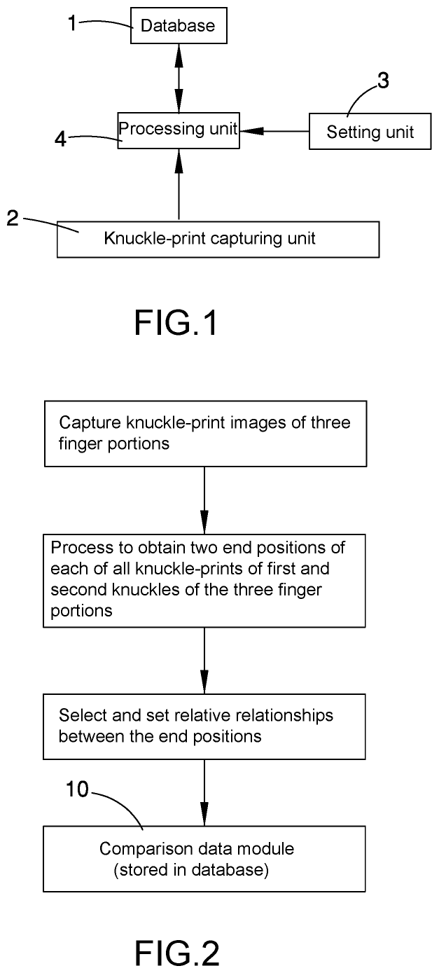

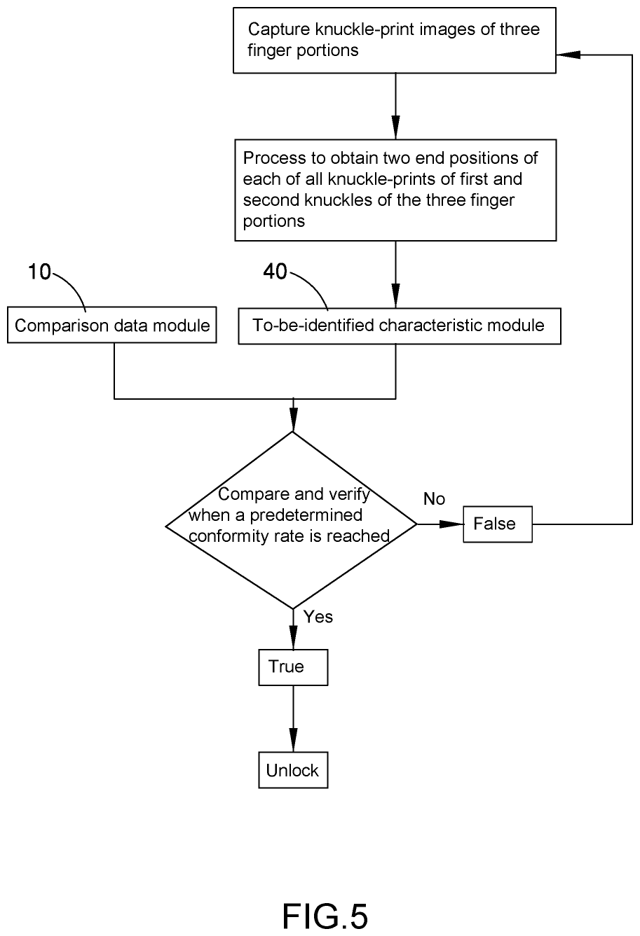

Please refer to FIGS. 1 to 5, a knuckle-print identification system of the invention includes a database 1, a knuckle-print capturing unit 2, a setting unit 3 and a processing unit 4.

The database 1 stores a comparison data module 10, and the comparison data module 10 includes end positions of the knuckle-prints, which include two ends of first knuckle-prints, two ends of second knuckle-prints and two ends of second sub-knuckle-prints of three finger portions 5 in a close state, and data representing relative relationships thereof.

The knuckle-print capturing unit 2 captures knuckle-print images of the three finger portions 5.

The setting unit 3 may select the end positions of the knuckle-prints and set the relative relationships thereof.

The processing unit 4 is electrically connected to the database 1, the knuckle-print capturing unit 2 and the setting unit 3. The processing unit 4 is configured with a predetermined conformity rate in advance, and processes the knuckle-print images of the three finger portions 5 captured by the knuckle-print capturing unit 2, calculates to obtain data representing the end positions of the knuckle-prints of the three finger portions 5, selects the end positions of the knuckle-prints in conjunction with the setting unit 3 and sets the relative relationships thereof to form the comparison data module 10 and then store the comparison data module 10 into the database 1, and to form a to-be-identified characteristic module 40 and compare the to-be-identified characteristic module 40 with the comparison data module 10 to obtain an identification conformity rate. When the identification conformity rate is higher than or equal to the predetermined conformity rate, the processing unit 4 judges as true, and then unlocks or allows further operations. When the identification conformity rate is lower than the predetermined conformity rate, the processing unit 4 judges as fault, and then it needs to perform the action of capturing the knuckle-print images again. In general, the predetermined conformity rate is defined in the range from 70% to 90%, and the best conformity rate is 80%.

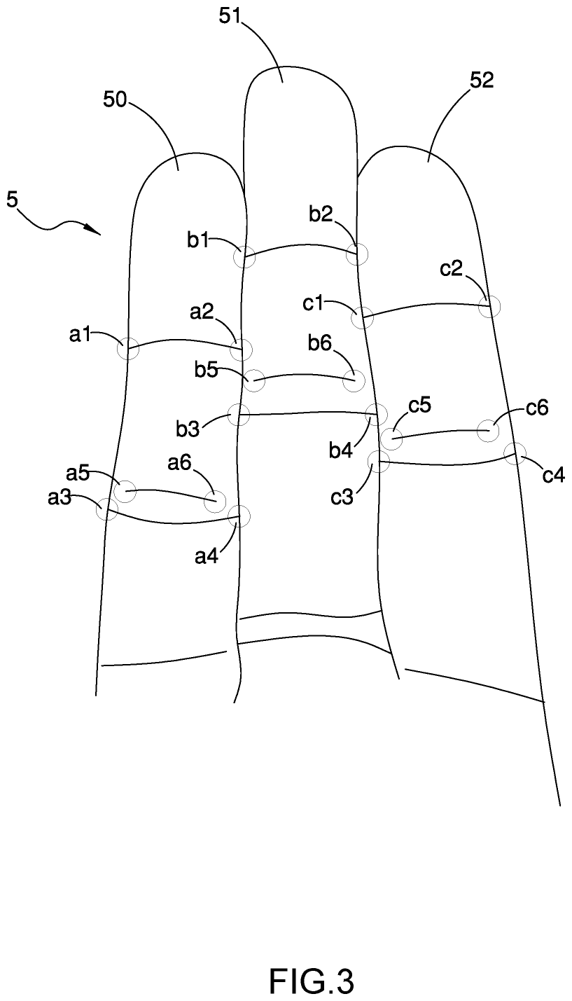

As shown in FIG. 3, the three finger portions 5 may be the index finger, the middle finger and the ring finger that are close together. The first finger 50 has the left end position a1 of the first knuckle-print, the right end position a2 of the first knuckle-print, the left end position a3 of the second knuckle-print, the right end position a4 of the second knuckle-print, the left end position a5 of the second sub-knuckle-print and the right end position a6 of the second sub-knuckle-print. The second finger 51 has the left end position b1 of the first knuckle-print, the right end position b2 of the first knuckle-print, the left end position b3 of the second knuckle-print, the right end position b4 of the second knuckle-print, the left end position b5 of the second sub-knuckle-print and the right end position b6 of the second sub-knuckle-print. The third finger 52 has the left end position c1 of the first knuckle-print, the right end position c2 of the first knuckle-print, the left end position c3 of the second knuckle-print, the right end position c4 of the second knuckle-print, the left end position c5 of the second sub-knuckle-print and the right end position c6 of the second sub-knuckle-print. The above-mentioned second sub-knuckle-print is located at a position near and above a corresponding one of the second knuckle-prints.

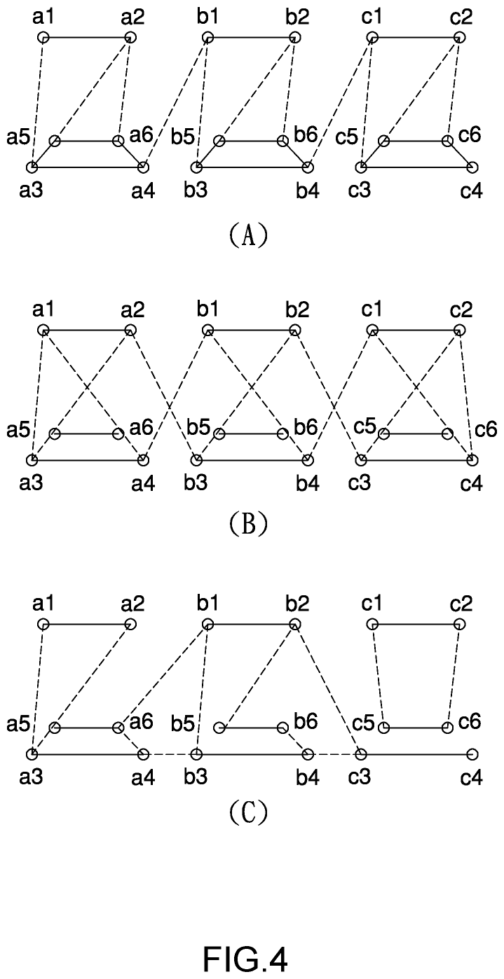

As shown in FIG. 4, the end positions of the knuckle-prints may be selected according to the requirement, and then the relative relationships thereof may be set. However, the relative relationships thereof may be broken lines or geometric patterns formed by connection lines between the end positions of the knuckle-prints.

Before the knuckle-print identification system of the invention is used, it is necessary to use the knuckle-print capturing unit 2 in advance to capture the knuckle-print images of the three finger portions 5 in a close state, and then use the processing unit 4 to process the knuckle-print images captured by the knuckle-print capturing unit 2, to calculate to obtain data representing the end positions of the knuckle-prints of the three finger portions 5 and to select the end positions of the knuckle-prints and set the relative relationships thereof in conjunction with the setting unit 3 again, and to form the comparison data module 10 and then store the comparison data module 10 into the database 1, as shown in FIGS. 1 and 2.

When the knuckle-print identification system of the invention is used, the knuckle-print capturing unit 2 is used to capture the knuckle-print images of the three finger portions 5 in a close state, and then the processing unit 4 is used to process the knuckle-print images captured by the knuckle-print capturing unit 2 and calculate to obtain data representing the end positions of the knuckle-prints of the three finger portions 5 and relative relationships thereof, and to form a to-be-identified characteristic module 40 and then compare the to-be-identified characteristic module 40 with the comparison data module 10 to obtain an identification conformity rate. When the identification conformity rate is higher than or equal to the predetermined conformity rate, the processing unit 4 judges as true, and then unlocks or allows further operations. When the identification conformity rate is lower than the predetermined conformity rate, the processing unit 4 judges as fault, and then the knuckle-print images needs to be captured again.

In the knuckle-print identification system provided by the invention, because the comparison data module 10 includes 18 end positions of knuckle-prints, which are the two ends of first knuckle-prints, the two ends of second knuckle-prints and the two ends of second sub-knuckle-prints of the three finger portions 5 in a close state, at most 18 identification feature points are obtained, and the corresponding relationships with more changes may be relatively produced according to the 18 identification feature points. Therefore, the system is more secure. Moreover, the relative relationships may be formed by selecting an appropriate number of end positions of knuckle-prints according to personal needs so as to achieve the effect of adjusting the level of security.

In this invention, the comparison data module 10 may also include only the end positions of the knuckle-prints, which are the two ends of first knuckle-prints and the two ends of second knuckle-prints of the three finger portions 5 in a close state, and the corresponding relationships thereof according to actual needs, so 12 identification feature points are obtained, and this still has the better security than the conventional knuckle-print identification system.

In summary, because the invention has the above-mentioned advantages and practical values, and no similar products are published, the application requirements of the invention patent have been satisfied, and the application is filed according to the law.

What is claimed is:

1. A knuckle-print identification system, comprising:
a database storing a comparison data module, wherein the comparison data module comprises two end positions of each of all first knuckle-prints of three finger portions and two end positions of each of all second knuckle-prints of the three finger portions in a close state, and data representing relative relationships thereof;
a knuckle-print capturing unit capturing knuckle-print images of the three finger portions; and
a processing unit electrically connected to the database and the knuckle-print capturing unit, wherein the processing unit is configured with a predetermined conformity rate in advance, and processes the knuckle-print images captured by the knuckle-print capturing unit and calculates to obtain the end positions of the knuckle-prints and relative relationship data to form the comparison data module and then store the comparison data module into the database, and to form a to-be-identified characteristic module and compare the to-be-identified characteristic module with the comparison data module to obtain an identification conformity rate, wherein the processing unit judges as true when the identification conformity rate is higher than or equal to the predetermined conformity rate, and the processing unit judges as fault when the identification conformity rate is lower than the predetermined conformity rate.

2. The knuckle-print identification system according to claim 1, wherein the comparison data module comprises the two end positions of each of all second sub-knuckle-prints of the three finger portions and data representing relative relationships thereof, and the second sub-knuckle-print is located at a position near and above a corresponding one of the second knuckle-prints.

3. The knuckle-print identification system according to claim 1, further comprising a setting unit, wherein the setting unit is electrically connected to the processing unit, and selects the end positions of the knuckle-prints and sets the relative relationships thereof, and the processing unit forms the comparison data module in conjunction with the end positions of the knuckle-prints and the relative relationships, selected and set by the setting unit, and stores the comparison data module into the database.

4. The knuckle-print identification system according to claim 2, further comprising a setting unit, the setting unit is electrically connected to the processing unit and selects the end positions of the knuckle-prints and set the relative relationships between the end positions of the knuckle-prints, and the processing unit forms the comparison data module in conjunction with the end positions of the knuckle-prints and the relative relationships, selected and set by the setting unit, and stores the comparison data module into the database.

5. The knuckle-print identification system according to claim 3, wherein the three finger portions are an index finger, a middle finger and a ring finger close together.

6. The knuckle-print identification system according to claim 4, wherein the three finger portions are an index finger, a middle finger and a ring finger close together.

7. The knuckle-print identification system according to claim 3, wherein the predetermined conformity rate ranges from 70% to 90%.

8. The knuckle-print identification system according to claim 4, wherein the predetermined conformity rate ranges from 70% to 90%.

9. The knuckle-print identification system according to claim 3, wherein the relative relationships between the end positions of the knuckle-prints are broken lines formed by connection lines between the end positions of the knuckle-prints.

10. The knuckle-print identification system according to claim 4, wherein the relative relationships between the end positions of the knuckle-prints are broken lines formed by connection lines between the end positions of the knuckle-prints.

11. The knuckle-print identification system according to claim 3, wherein the relative relationships between the end positions of the knuckle-prints are geometric patterns formed by connection lines between the end positions of the knuckle-prints.

12. The knuckle-print identification system according to claim 4, wherein the relative relationships between the end positions of the knuckle-prints are geometric patterns formed by connection lines between the end positions of the knuckle-prints.
